(19) United States
(12) Patent Application Publication
(10) Pub. No.: US 2026/0042075 A1
(43) Pub. Date: Feb. 12, 2026

(54) GRAVIMETRIC BLENDING SYSTEM

(71) Applicant: CFR Engines, Inc., Pewaukee, WI (US)

(72) Inventors: Abhishek S. Shah, Milwaukee, WI (US); Robert A. Sinur, Brookfield, WI (US); Ravi Manchiraju, Port Washington, WI (US); Joshua J. Rayeske, Menomonee, WI (US)

(21) Appl. No.: 19/291,472

(22) Filed: Aug. 5, 2025

Related U.S. Application Data
(60) Provisional application No. 63/679,834, filed on Aug. 6, 2024.

(51) Int. Cl. B01F 35/88; B01F 35/71

(52) U.S. Cl. CPC B01F 35/881; B01F 35/7176

(57) ABSTRACT

A gravimetric blending system can include fluid storage reservoirs, a pivotable dispensing arm having dispensing nozzles, wherein each dispensing nozzle is configured to dispense a predetermined amount of fluid from each fluid storage reservoir a fluid container, and a scale configured to detect a weight applied to the scale. The gravimetric blending system may further include a controller configured to receive user inputs, identify a fluid contained within one of the fluid storage reservoirs that will contribute to the blend and the required weight of the fluid. The controller may be further configured to identify the expected change in weight to be detected by the scale, cause an amount of the fluid to be dispensed, detect the weight applied to the scale after the fluid has been dispensed, compare the detected weight to the expected change in weight, and determine if the expected weight of the fluid was dispensed.

### CROSS-REFERENCE TO RELATED APPLICATIONS

This application claims priority to and the benefit of U.S. Provisional Patent Application No. 63/679,834, filed on Aug. 6, 2024, the entirety of which is incorporated herein by reference for all purposes.

### BACKGROUND

Volumetric blending systems may struggle to adapt to changes in operating conditions or variations in fuel properties over time. Factors such as fluctuations in temperature, pressure, or the characteristics of fuel components can affect the accuracy of volume-based measurements and the performance of the blending process. Another drawback is the potential for inaccuracies in blending ratios due to variations in the density and viscosity of different fuel components. These variations can result in inconsistent blending ratios, leading to suboptimal fuel quality and performance.

Another downside of volumetric blending is the susceptibility to human error in readings and adjustments. Operators manually control the flow rates of fuel components based on volume measurements, which introduces the possibility of mistakes in setting the correct ratios. Human errors such as misreading gauge readings, miscalculating adjustments, or neglecting to calibrate equipment can lead to deviations from the intended blend specifications. These errors can compromise the quality and consistency of the blended fuel, potentially causing issues such as engine inefficiency, increased emissions, or equipment damage. Overall, while volumetric blending offers simplicity and cost-effectiveness, its limitations in accuracy, susceptibility to human error, and inability to adapt to changing conditions make it less suitable for applications where precise control over blend ratios and quality is essential.

### SUMMARY

According to a first aspect, a gravimetric blending system can include a plurality of fluid storage reservoirs and a pivotable dispensing arm having a plurality of dispensing nozzles, each dispensing nozzle coupled to one of the plurality of fluid storage reservoirs, wherein each dispensing nozzle is configured to dispense a predetermined amount of fluid from each fluid storage reservoir into one or more fluid containers. The gravimetric blending system may further include wherein each of the plurality of fluid storage reservoirs having a pump configured to pump a fluid from the respective fluid storage reservoir to a respective dispensing nozzle when activated and a solenoid valve having a flow path between the respective fluid storage reservoir and the respective dispensing nozzle and configured to transition between an open state where the fluid may flow through the flow path and a closed state where fluid may not flow through the flow path. The gravimetric blending system may further include a scale having a configured to detect a weight applied to the scale and a user interface configured to receive user inputs indicative of a blend of fluids to be mixed from the fluids contained within the plurality of fluid storage reservoirs. The gravimetric blending system may further include a controller configured to receive the user inputs, identify a first fluid contained within one of the plurality of fluid storage reservoirs that will contribute to the blend and the weight of the first fluid required from the identified fluid storage reservoir to produce the blend. The controller may be further configured to identify the expected change in weight to be detected by the scale based on the identified weight of the first fluid to be dispensed. The controller may be further configured to cause the pump associated with the identified fluid storage reservoir to activate and the solenoid valve associated with the identified fluid storage reservoir to actuate to the open state to dispense the identified weight of the first fluid from the identified fluid storage reservoir. The controller may be further configured to detect the weight applied to the scale after the identified weight of the first fluid has been dispensed, compare the detected weight to the expected change in weight, and determine if the expected weight of the first fluid was dispensed.

According to a second aspect, a gravimetric blending system can include one or more memory devices configured to store instructions thereon that, when executed by one or more processors, cause the one or more processors to in response to receiving a user's instructions at a user interface configured to receive user inputs indicative of a blend of fluids to be dispensed from a plurality of fluid storage reservoirs, wherein each fluid storage reservoir is coupled to a respective dispensing nozzle of a plurality of dispensing nozzles contained within a pivotable dispensing arm, identify a first fluid contained within one of the plurality of fluid storage reservoirs that will contribute to the blend and the expected weight of the first fluid required from the identified fluid storage reservoir to produce the blend. The one or more processors may be further cased to sense if a fluid container is present on a scale by at least one sensor and identify the expected change in weight to be detected by the scale based on the expected weight of the first fluid to be dispensed. The one or more processors may be further cased to in response to sensing that a fluid container is present, activate a motor to pivot the pivotable dispensing arm such that the plurality of dispensing nozzles are positioned above the sensed fluid container. The one or more processors may be further cased to dispense an amount of the first fluid into the sensed fluid container and detect the weight applied to the scale after the amount of the first fluid has been dispensed. The one or more processors may be further cased to compare the detected weight of the first fluid dispensed into the sensed fluid container with the expected change in weight. The one or more processors may be further cased to determine if the expected weight of the first fluid was dispensed.

According to a third aspect, a method of using a gravimetric blending system may include receiving a user's instructions at a user interface configured to receive user inputs indicative of a blend of fluids to be dispensed from a plurality of fluid storage reservoirs, wherein each fluid storage reservoir is coupled to a respective dispensing nozzle of a plurality of dispensing nozzles contained within a pivotable dispensing arm, identify a first fluid contained within one of the plurality of fluid storage reservoirs that will contribute to the blend and the expected weight of the first fluid required from the identified fluid storage reservoir to produce the blend. The method may further include sensing if a fluid container is present on a scale by at least one sensor. The method may further include identifying the expected change in weight to be detected by the scale based on the expected weight of the first fluid to be dispensed. The method may further include in response to sensing that a fluid container is present, activate a motor to pivot the pivotable dispensing arm such that the plurality of dispensing nozzles are positioned above the sensed fluid container. The method may further include dispensing an amount of the first fluid into the sensed fluid container. The method may further include detecting the weight applied to the scale after the amount of the first fluid has been dispensed. The method may further include comparing the detected weight of the first fluid dispensed into the sensed fluid container with the expected change in weight. The method may further include determining if the expected weight of the first fluid was dispensed.

### BRIEF DESCRIPTION OF THE DRAWINGS

The disclosure will become more fully understood from the following detailed description, taken in conjunction with the accompanying representative figures, wherein like reference numerals refer to like elements, in which:

FIG. 1 is a front side perspective view of a gravimetric blending system, according to one embodiment.

FIG. 2 is a block diagram of the gravimetric blending system of FIG. 1.

FIG. 3 is a perspective view of a dispensing portion of the gravimetric blending system of FIG. 1.

FIG. 4 is a perspective view of a dispensing tip of the gravimetric blending system of FIG. 1.

FIG. 5A is a rear view of a fluid storage portion of the gravimetric blending system of FIG. 1.

FIG. 5B is a perspective view of the fluid storage portion of FIG. 5A.

FIG. 6 is a diagram of the fluid storage portion of FIG. 5A.

FIG. 7 is a front view of a user interface of the gravimetric blending system of FIG. 1.

FIG. 8 is a rear view of the gravimetric blending system of FIG. 1 coupled to an external fuel source.

FIG. 9 is a flowchart illustrating a method for operating the gravimetric blending system of FIG. 1.

The drawings are not necessarily to scale and certain features may be shown exaggerated in scale or in somewhat schematic form in the interest of clarity and conciseness.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

The conventional setup for blending fuels for testing octane, cetane, or other fuel ratings includes an operator dispensing out the component parts of the fuel blend into a graduated cylinder. Then the operator must visually verify that the correct amount of each component fluid is present in the blend, which introduces the potential for various fuel blends to be operator dependent and reduces precision. The accuracy of the fuel blends and the precision (e.g., repeatability) with which the fuel blends are produced have a significant impact on automotive/research industries. For example, producing accurate and precise fuel blends enables automotive/research industries to effectively test new fuel blends (e.g., diesel, gasoline, aviation fuel), and compare the test results to known reference fuels. The systems and methods of the present disclosure provide a gravimetric blending system 10 that greatly improves the precision, accuracy, and operator efficiency of the fuel blends produced.

A gravimetric blending system 10 creates blends of fuels based on the weights of the various fluids that contribute to the blend. These weight-based measurements offer greater accuracy and reliability of the measurements of the component parts of the blends. This is due to the mass of a fluid being known and not fluctuating or being influenced by environmental conditions such as pressure, temperature, etc.

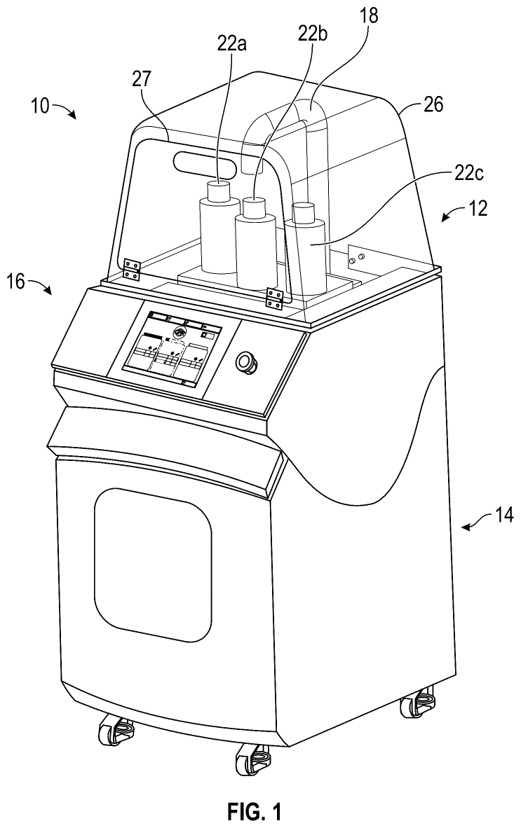

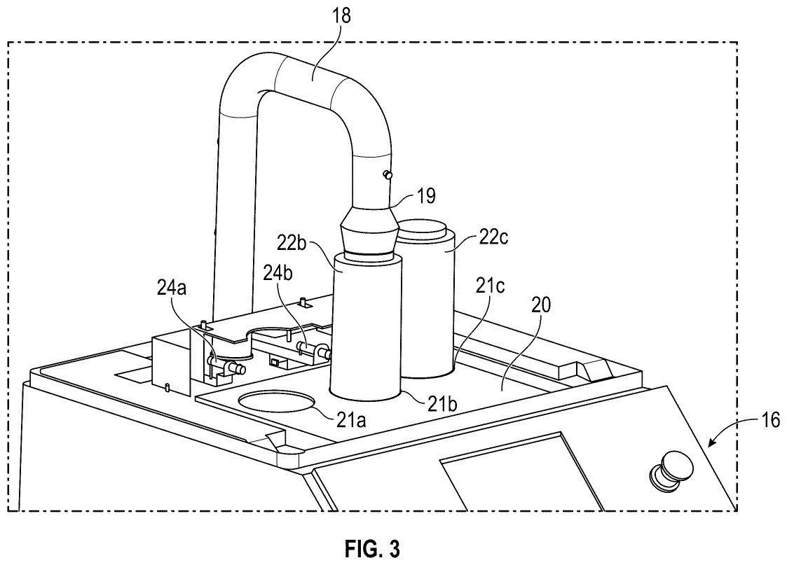

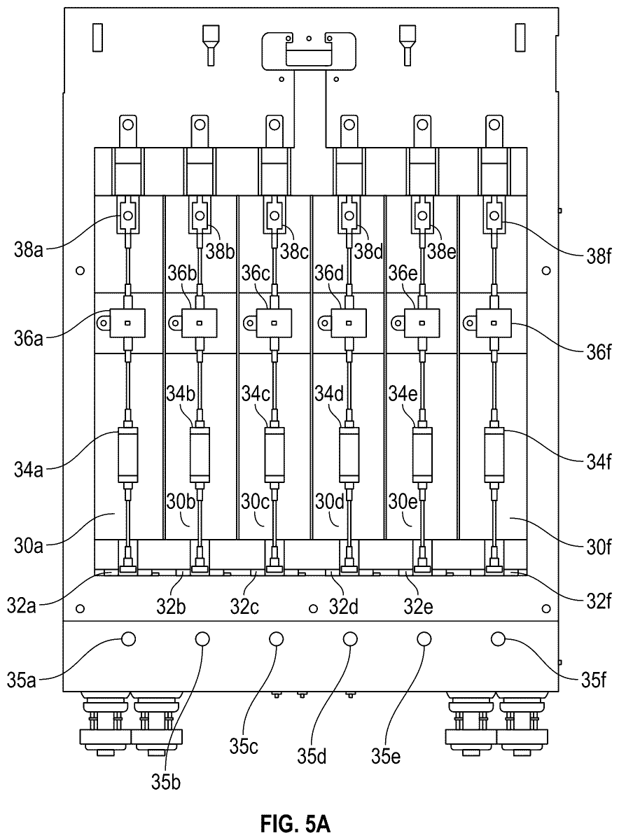

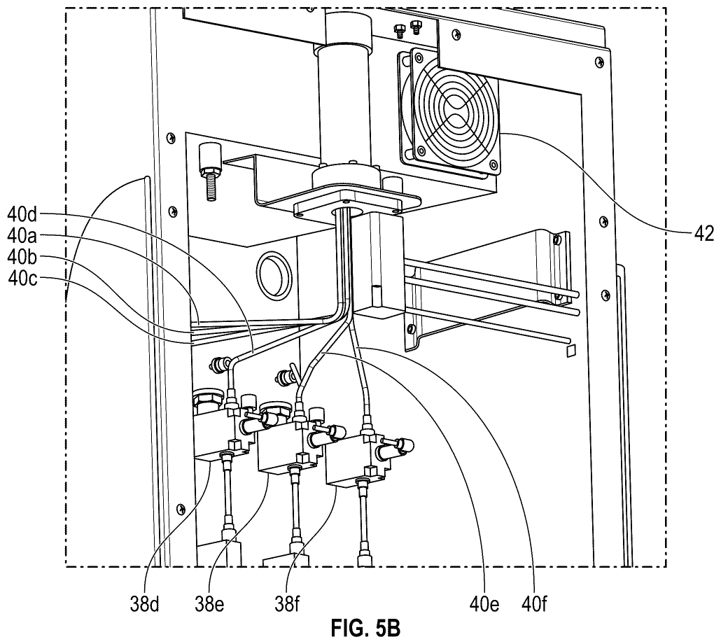

FIGS. 1-6 depicts a gravimetric blending system 10 that is used to produce various fuel blends. The gravimetric blending system 10 includes a dispensing portion 12, a fluid storage portion 14, and a human-machine interface (HMI) 16. The dispensing portion 12 includes a pivotable dispensing arm 18, a scale 20 configured to receive or otherwise accept one or more fuel blend containers 22. The pivotable dispensing arm 18 is configured to pivot approximately 35 degrees in the clockwise direction and approximately 35 degrees the counterclockwise direction to position the dispensing end of the pivotable dispensing arm 18 above one or more dispensing locations 21a, 21b, and 21c (collectively 21), on the scale 20 where the one or more fuel blend containers 22 may be positioned. Each of the dispensing locations 21 has a corresponding object detection sensor 24a, 24b, and 24c (collectively 24) configured to detect the presence or absence of a fuel blend container 22 at a respective dispensing location 21. The scale 20 includes one or more weight sensors 23 configured to measure or otherwise detect the weight of objects placed thereon.

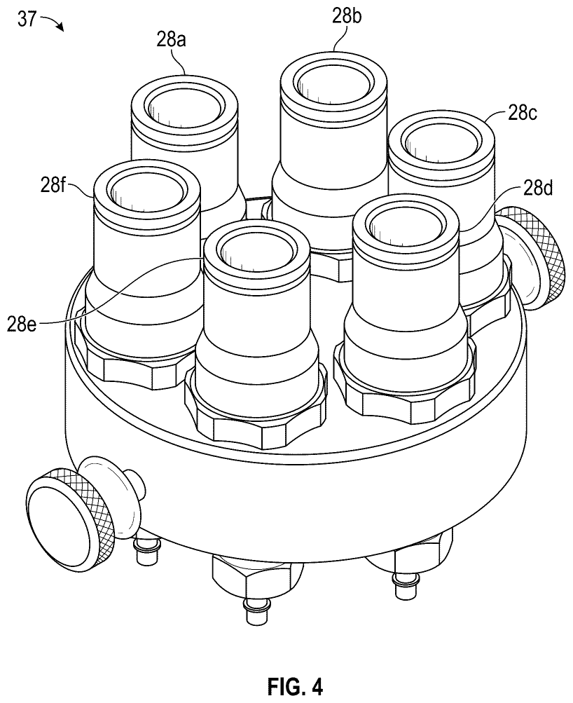

The pivotable dispensing arm 18 is configured to house, contain, or otherwise enclose at least a portion of the fuel lines 40a, 40b, 40c, 40d, 40e, and 40f (collectively 40) therein and the dispensing tip 37 (as shown in FIG. 4) about the outlet end of the pivotable dispensing arm 18. There, the ends of the respective fuel lines 40 are coupled to dispensing nozzles 28a, 28b, 28c, 28d, 28e, and 28f (collectively 28) such that each respective dispensing nozzle 28 is in fluid communication with a respective fuel line 40. The dispensing nozzles 28 are configured to receive the fluid from the fuel lines 40 and direct the fluid into the fuel container 22 positioned below it. The dispensing nozzles 28 are positioned radially about the circumference of the dispensing tip 37. In this manner, each dispensing nozzle 28 is secured in place so as to ensure that the dispensing nozzle 28 is directed downwards towards the fuel container 22 and does not shift directions in between dispensing actions. In some embodiments, the pivotable dispensing arm 18 can also include a spill guard 19 mechanically coupled to the outlet end of the pivotable dispensing arm 18. The spill guard 19 is sized and shaped to minimize the amount fluid that exits the dispensing tip 37 from spilling onto the scale 20 or other proximate components while still allowing the pivotable dispensing arm 18 to pivot within the dispensing portion 12 as normal.

The pivotable dispensing arm 18 is mechanically coupled with a stepper motor 25 that is configured to pivot the pivotable dispensing arm 18 an amount in the clockwise direction and the counterclockwise direction in response to receiving a command from the HMI 16. The stepper motor 25 will move in discrete steps in response to pulses sent to it by the motor control module 114 of the HMI 16 (FIG. 4). By controlling the number and timing of these pulses the motor control module 114 controls the angle of rotation of the stepper motor 25 and, consequently, the pivotable dispensing arm 18 coupled to it. To pivot the pivotable dispensing arm 18 in the clockwise direction, the motor control module 114 sends a sequence of pulses to the stepper motor 25 that causes it to rotate in clockwise direction. To pivot the pivotable dispensing arm 18 in the counterclockwise direction, the motor control module 114 sends a sequence of pulses to the stepper motor 25 that causes it to rotate in counterclockwise direction. This method of control is often referred to as open-loop control because there is no feedback mechanism to confirm the actual position of the pivotable dispensing arm 18. Instead, the motor control module 114 relies solely on the assumption that the stepper motor 25 will move the pivotable dispensing arm 18 by the desired amount based on the number of pulses sent to it.

In other embodiments, the stepper motor 25 is equipped with or otherwise includes an encoder (not shown). The encoder provides feedback on the actual position of the stepper motor's 25 shaft, allowing the motor control module 114 to monitor and adjust the position as needed. In such embodiments, the motor control module 114 is capable of receiving feedback from the encoder of the stepper motor 25 and adjusting the stepper motor's 25 movement accordingly. The motor control module 114 continuously compares the desired position of the stepper motor's 25 shaft, which corresponds with the position of the pivotable dispensing arm 18, with the actual position provided by the encoder of the stepper motor 25. In response to detecting a deviation between the desired and actual positions, the motor control module 114 can be configured to generate a correction signal to adjust the stepper motor's 25 movement accordingly. In many embodiments, the motor control module 114 is configured to function or operate as a proportional-integral-derivative (PID) controller. In such embodiments, the motor control module 114 calculates the correction signal based on the detected error (e.g., difference between desired and actual positions), the integral of the error over time, and the rate of change of the error. The motor control module 114 determines the direction in which the stepper motor 25 needs to rotate based on the error signal. If the error is positive, indicating that the actual position is less than the desired position, then the stepper motor 25 should rotate in one direction to reduce the error. If the error is negative, the stepper motor 25 should rotate in the opposite direction. This setup is referred to as closed-loop control because it continuously monitors the position of the pivotable dispensing arm 18 and adjusts the pulses sent to the stepper motor 25 accordingly to maintain the desired performance.

The object detection sensors 24 are configured to detect the presence or absence of a fuel blend container 22 positioned about a corresponding dispensing location 21. The object detection sensors 24 are communicatively and electrically coupled to the HMI 16 and are configured to communicate to the HMI 16 if a fuel blend container 22 is detected at the respective dispensing location 21. The object detection sensors 24 can be capacitive proximity sensors, capacitive touch sensors, or any other suitable or desirable sensor capable of detecting the presence or absence of an object about a respective dispensing location 21. A capacitive proximity sensor detects the presence or absence of an object without physically contacting the object. Capacitive proximity sensor generate an electrostatic field, and when an object enters this field, it causes a change in capacitance, which is detected by the capacitive proximity sensor. Capacitive touch sensors detect the presence of a conductive object, such as a fuel blend container 22, by measuring changes in capacitance when the object comes into contact with or approaches the sensor surface. Capacitive touch sensors offer advantages like high sensitivity, durability, and resistance to environmental factors.

The scale 20 is configured to detect the weight of objects placed thereon. The weight sensors 23 may be embedded with, integrated with, or otherwise mechanically coupled to the scale 20 such that the weight sensors 23 can detect the weight of one or more objects placed on the scale 20. The weight sensors 23 of the scale 20 are communicatively and electrically coupled to the HMI 16 and are configured to communicate the weight detected by the weight sensors 23 to the HMI 16. For some embodiments, the scale 20 includes only a single weight sensor 23 configured to measure or detect the weight or mass of all objects positioned on the scale 20 irrespective of their position on the scale 20. However, other embodiments, each dispensing location 21 includes a respective weight sensor 23 to measure or detect the weight of objects placed on each respective dispensing location 21 independently of the weight of an object placed on an adjacent dispensing location 21. For example, a weight sensor 23 corresponding to dispensing location 21A may detect a weight of 10 grams on dispensing location 21A, the weight sensor 23 corresponding to dispensing location 21B may detect a weight of 12 grams, while the weight sensor 23 corresponding to dispensing location 21C detects no weight (i.e., 0 grams). In embodiments that utilize a single weight sensor 23 for the scale 20, the weight sensor 23 would detect a total weight of 22 grams for the example provided above.

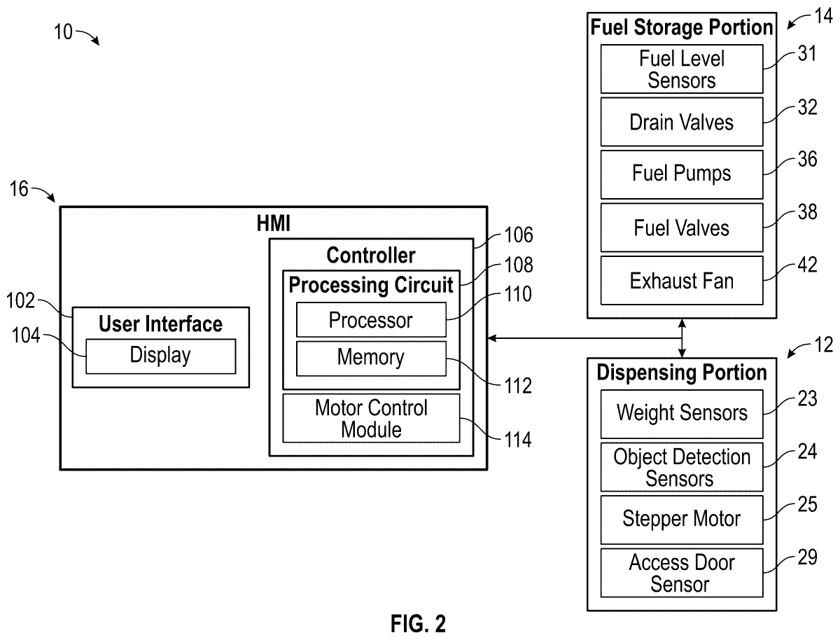

With reference to FIG. 1, the cover 26 is positioned to contain or otherwise enclose the pivotable dispensing arm 18, the scale 20, and the dispensing locations 21 with fuel blend containers 22 placed thereon. The cover 26 is configured to protect the surrounding environment from unintended splashes or spills caused by dispensing fluids into one or more of the fuel blend containers 22 from the pivotable dispensing arm 18. In many embodiments, the cover 26 is formed of a polycarbonate that is resistant to toluene. However, it should be understood that the cover 26 may be formed of any suitable or desirable material that is sufficiently resistant to chemicals or fluids contained within the respective fuel reservoirs 30. The access door 27 is mechanically coupled to the cover 26 to allow for or provide access to the internal portion of the cover 26. The access door 27 may be configured in an open state to provide access to the internal portion of the cover to facilitate a user placing or positioning empty fuel blend containers 22 on a dispensing location 21. The access door 27 may also be configured in a closed state to protect the HMI 16 and other components of the gravimetric blending system 10 from spills or splashes caused by dispensing a fluid from the pivotable dispensing arm 18 into a fuel blend container 22. The access door 27 may be formed of any material that the cover 26 is formed of. The cover 26 may also include an access door sensor 29 (shown in FIG. 2), that is configured to sense or detect if the access door 27 is configured in the closed state or the open state. In many embodiments, when the access door 27 is configured in the open state, the access door 27 covers or substantially covers the display 104 of the HMI 16 to prevent fluids spilling out of a fuel blend container 22 from spilling onto the display 104 while removing a recently filled fuel blend container 22 from the internal portion of the cover 26. For some embodiments, the access door sensor 29 is communicatively coupled to the HMI 16 and the HMI 16 is configured to only begin dispensing fluids to generate a blend if the access door sensor 29 detects or senses that the access door 27 is in the closed state. According to many embodiments, the access door sensor 29 is an electrical contact switch that detects or senses when the access door 27 is latched or otherwise secured in the closed state. While in other embodiments, the access door sensor 29 can be a proximity sensor, a hall effect sensor, a limit switch, or any other type of sensor capable of communicatively coupling with the HMI 16 and detecting or sensing if the access door 27 is positioned in the open state or the closed state.

With specific reference to FIGS. 1, 2, 5A, 5B, and 6, the fluid storage portion 14 includes a plurality of fuel cylinders, tanks, or reservoirs 30a, 30b, 30c, 30d, 30e, and 30f (collectively 30), a plurality of drain valves 32a, 32b, 32c, 32d, 32e, and 32f (collectively 32), a plurality of fuel filters 34a, 34b, 34c, 34d, 34e, and 34f (collectively 34), a plurality of filling ports 35a, 35b, 35c, 35d, 35e, and 35f (collectively 35), a plurality of fuel pumps fuel pump 36a, 36b, 36c, 36d, 36e, and 36f (collectively 36), a plurality of fuel valves 38a, 38b, 38c, 38d, 38e, and 38f (collectively 38), a plurality of fuel lines 40a, 40b, 40c, 40d, 40e, and 40f (collectively 40), and an exhaust fan 42. In the illustrated embodiment, the fuel storage portion 14 includes six fuel reservoirs 30 and a corresponding number of drain valves 32, fuel filters 34, fuel pumps 36, fuel valves 38, and fuel lines 40. Each fuel valve 38 is in fluid communication with and arranged downstream of its respective fuel reservoir 30 and is configured to selectively provide or inhibit fluid communication between the respective fuel reservoir 30 and the respective fuel line 40. In some embodiments, each of the fuel valves 38 are solenoid-operated valve (e.g., a solenoid-operated ball valve, a solenoid-operated spool valve, a solenoid-operated gate valve, etc.). In some embodiments, the fluid storage portion 14 may include more or less than six fuel reservoirs 30 and a corresponding number of drain valves 32, fuel filters 34, fuel pumps 36, fuel valves 38, and fuel lines 40. For many embodiments, at least one fuel reservoir 30 is coupled with a heating module (not shown) that is configured to heat the respective fuel reservoir 30 if the fluid contained within the respective fuel reservoir 30 drops below a predefined temperature. Some fluids that may be contained within one of the fuel reservoirs 30, such as cetane hexadecane may begin to freeze or otherwise begin to transition from a fluid state to a solid state at or about room temperature. The HMI 16 may utilize a PID (Proportional-Integral-Derivative) control loop to determine when to activate the heating module based on the ambient temperature. In many embodiments, multiple fuel reservoirs 30 may be coupled with a respective heating module and each heating module may be configured to activate at different ambient temperatures. For embodiments that utilize multiple heating modules, the heating modules may be coupled to fuel reservoirs 30a and 30f such that the heating modules may be positioned about the outer surface of the fuel storage portion 14 such that when each respective heating module is activated, the heat generated will be substantially contained within or otherwise directed to fuel reservoir 30a and 30f while minimizing heating of the remaining fuel reservoirs 30.

In many embodiments, each respective fuel reservoir 30 holds or contains a fluid that is different from the fluids that are contained in the adjacent fuel reservoirs 30. In other embodiments, only half of the fuel reservoirs 30 contain a distinct fluid type. Examples of fluid types that the fuel reservoirs 30 may contain are ISO octane, 80 octane, toluene, cetane hexadecane, nCetane, HMN (heptamethylnonane), T-cetane, U-cetane, PMH (Pentamethyl Heptane), and nHeptane. It should be understood, that the fuel reservoirs 30 may contain or hold any suitable or desirable fluid that may be utilized as a component part of a fuel blend.

The drain valves 32 are each mechanically coupled to and in fluid communication with a respective fuel reservoir 30 and a drain line or conduit 33. The drain valves 32 are configured to selectively provide or inhibit fluid communication between the drain line 33 and the respective fuel reservoir 30. In some embodiments, each of the drain valves 32 is a solenoid-operated valve (e.g., a solenoid-operated ball valve, a solenoid-operated spool valve, a solenoid-operated on/off valve, etc.).

Fuel filters 34 are arranged between and are mechanically coupled to a respective fuel reservoir 30 and a respective fuel pump 36. For example, a first fuel filter 34a is arranged between the first fuel reservoir 30a and the first fuel pump 36a, a second fuel filter 34b is arranged between the second fuel reservoir 30b and the second fuel pump 36b, and similarly repeated for each respective fuel reservoir 30. In some embodiments, each of the fuel filters 34 are preliminary fuel filters having a first porosity or otherwise being configured to filter particles having a first particle size (e.g., about 10 microns). In such embodiments, there can be a secondary fuel filter (not shown) having a second porosity or otherwise being configured to filter particles having a second particle size that is smaller than the first particle size (e.g., about 2 microns). Such secondary fuel filters may be positioned downstream of each respective fuel pump 36.

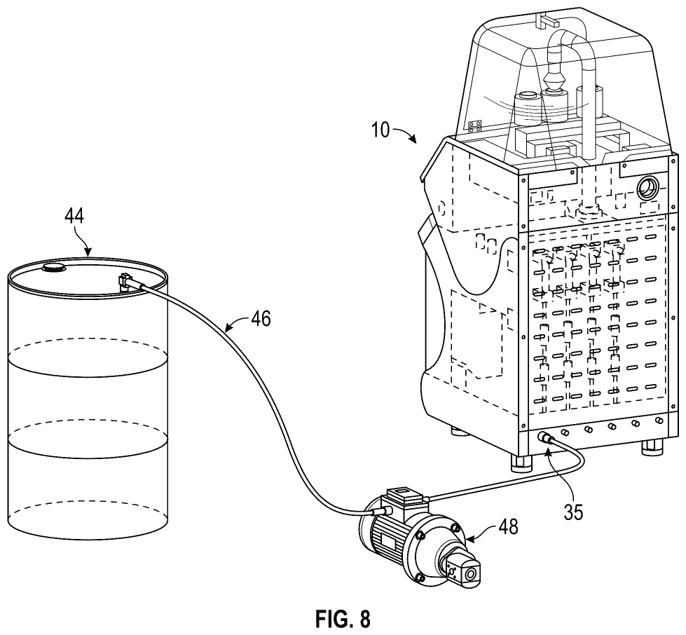

The filling ports 35 may be positioned upstream or downstream of the drain valves 32 and are configured to accept, receive, or otherwise couple to a fuel source for the respective fuel reservoir 30. In normal operation, the filling port 35 is capped such that a loss of containment by the drain valve 32 (in embodiments where the filling port is downstream of the drain valve 32) does not result in a loss of containment of the fuel in the respective fuel reservoir 30. In operation, as shown in FIG. 8, when a fuel reservoir 30 is in need of being filled with fluids, the filling port 35 may couple to an external fuel source 44 to facilitate filling of the fuel reservoir 30 via a hose 46 or any other member configured to configure the filling port 35 in fluid communication with the external fuel source 44. The external fuel source 44 may be positioned remotely from the fuel reservoirs 30. For some embodiments, an auxiliary pump 48 may be utilized to pump the fluid in the external fuel source 44 to the filling port 35.

The fuel pump 36 is configured to receive fuel from one of the fuel reservoirs 30. For example, an inlet of a respective fuel pump 36 is in fluid communication with the outlet of a respective fuel filter 34 and an outlet of the respective fuel pump 36 is in fluid communication with an inlet for a respective fuel valve 38. In this way, for example, opening one of the fuel valves 36 supplies the fuel within the corresponding one of the fuel reservoirs 30 to the dispensing portion 12 via the fuel line 40. In many embodiments, each fuel pump 36 is configured to operate at a constant speed and pressure. In such embodiments, the flow rate of the fluid from the fuel pump 36 is controlled by the controller 106 via pulse width modulation (PWM) techniques. PWM is a technique where the average power delivered to the fuel valve 38 is controlled by varying the width of the electrical pulses sent to it while keeping the frequency constant. In such embodiments, PWM can be used to regulate the amount of fluid being pumped by controlling the duration of time that the fuel valve 38 is in the open or closed positions. By adjusting the duty cycle of the PWM signal (the ratio of on-time to total cycle time), the controller 106 can control the average power delivered to the fuel valve 38. For example, a higher duty cycle means the fuel valve 38 is activated to the open position for a greater portion of the time, resulting in more fluid being pumped through it by the fuel pump 36. Conversely, a lower duty cycle means the fuel valve 38 is activated to the open position for a shorter duration, resulting in less fluid being pumped through it by the fuel pump 36.

The exhaust fan 42 is mechanically coupled to the fluid storage portion and is in fluid communication with the dispensing portion 12 about an inlet side of the exhaust fan 42 and an exhaust duct (not shown) about an outlet side of the exhaust fan 42. In this configuration, the exhaust fan 42 is configured to vent or otherwise direct any gases, vapors, fumes, or any other unwanted airborne gaseous matter from the dispensing portion 12 to the atmosphere via the exhaust duct. Specifically, the inlet side of the exhaust fan 42 is coupled to, or otherwise configured to exhaust gases contained within the internal portion of the cover 26 of the dispensing portion 12 to the exhaust duct while the dispensing portion 12 is dispensing fluids from the fluid storage portion 14. In some embodiments, the exhaust fan 42 is configured to activate or run while the access door 27 of the cover 26 is in the closed state. In such embodiments, the controller 106 can be configured to receive data points from the access door sensor 29 that is configured to sense or detect when the access door 27 of the cover 26 is positioned in the closed state. For example, in response to the access door sensor 29 detecting that the access door 27 has transitioned from the closed state to the open state, then the controller 106 can be configured to send a signal to the exhaust fan 42 to transition the exhaust fan 42 from the on or activated state to the off or deactivated state.

The HMI 16 of the gravimetric blending system 10 enables electronic control and calculation. The HMI 16 includes a user interface 102 and a controller 106 in communication with the user interface 102, the dispensing portion 12, and the fluid storage portion 14. The controller 106 includes a processing circuit 108 having a processor 110 and memory 112. The processing circuit 108 can be communicatively coupled to a communications module such that the processing circuit 108 and the various components thereof can send and receive data via the communications module. The processor 110 can be implemented as a general-purpose processor, an application specific integrated circuit (“ASIC”), one or more field programmable gate arrays (“FPGAs”), a group of processing components, or other suitable electronic processing components.

The memory 112 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 112 can be or include volatile memory or non-volatile memory. The memory 112 can include database components, object code components, script components, or any other type of information structure for supporting the various activities and information structures described in the present application. According to some embodiments, the memory 112 is communicatively coupled to the processor 110 via the processing circuit 108 and includes computer code for executing (e.g., by the processing circuit 108 and/or the processor 110) one or more processes, methods, or procedures described herein.

In general, the controller 106 is communicatively coupled with the user interface 102 and configured to receive various data inputs from the weight sensor(s) 23 of the scale 20, the object detection sensors 24, and the user interface 124. In some embodiments, the controller 106 receives data inputs from the fuel level sensor 31 and when the fuel level in a respective fuel reservoir 30 is below a predetermined threshold, the controller 106 instructs the user interface 102 to display the fuel level within the respective fuel reservoir 30. The user interface 102 can be configured to display a visual alert or to generate an audible alert that a certain component requires maintenance or otherwise requires the user's attention. For example, if one of the fuel level sensors 31 detects or senses that the fuel level in a respective fuel reservoir has dropped past a predetermined level, the controller 106 may instruct the user interface 102 to display a visual notification on the display 104 and produce an audible alarm.

In addition to the various data inputs provided to the controller 106, the controller 106 is configured to output various control signals to control operation of the dispensing portion 12 and the fluid storage portion 14. For example, the controller 106 is communicatively coupled with the fuel reservoir fuel level sensor 31, the drain valves 32, the fuel pumps 36, and the fuel valves 38. In some embodiments, the controller 106 is configured to selectively supply control signals to the fuel valves 38 to control the opening and closing thereof. For example, to supply fuel from a respective fuel reservoir 30 to the respective fuel line 40, the controller 106 may instruct the respective fuel valve 38 to actuate from a closed position to an open position, which provides fluid communication between the respective fuel reservoir 30 and dispensing portion 12 via the respective fuel pump 36 and the respective fuel line 40.

In some embodiments, the controller 106 is configured to selectively supply control signals to the drain valves 32 to control the opening and closing thereof. For example, to drain fuel from a respective fuel reservoir 30 and the corresponding fuel filter 34, the controller 106 may instruct the respective fuel valve 32 to close and instruct the respective drain valve 32 to open, which connects the respective fuel reservoir 30 and the respective fuel filter 34 to the drain line 33.

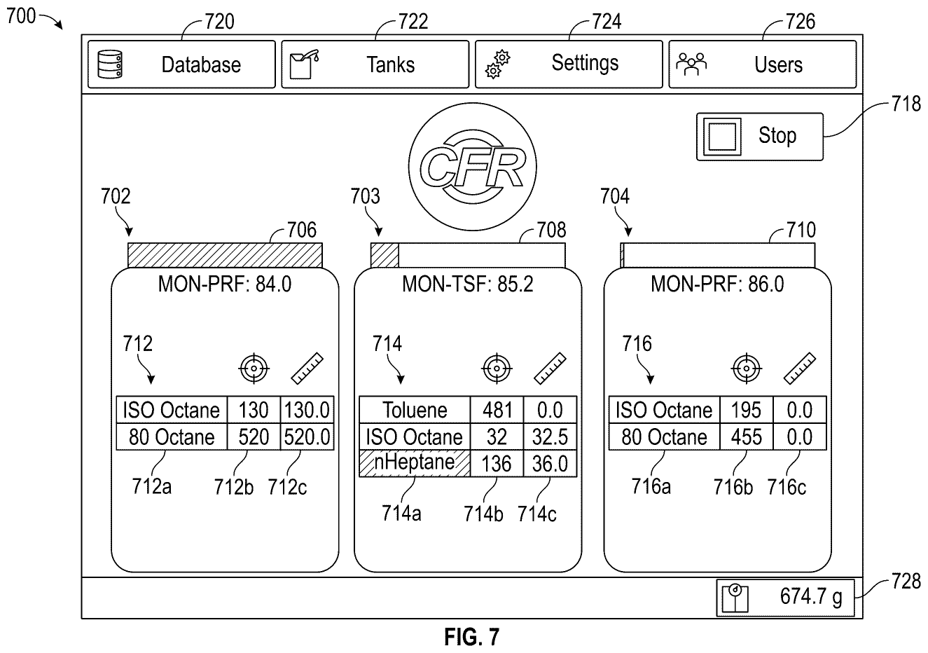

As shown in FIG. 7, the user interface 102 includes a fuel blend filling screen 700 that is displayed on the display 104. The fuel blend filling screen 700 may have user-selectable buttons (e.g., a digital button on the display 104) that corresponds with various display screens. The fuel blend filling screen 700 includes a plurality of fuel blends 702, 703, and 704 that correspond with the plurality of dispensing locations 21. For each fuel blend, the fuel blend filling screen 700 shows data associated with the particular fuel blend (712, 714, and 716), including the fuel type (712a, 714a, and 716a), expected amount of each fuel type (712b, 714b, and 716b), and measured amount of each fuel type (712c, 714c, and 716c). In addition, the fuel blend filling screen 700 displays the total weight 728 detected by the weight sensors 23. The fuel blending screen can also be configured to show a progress bar (706, 708, and 710) that corresponds to the progress of or the amount that each fuel blend 702, 703, and 704 is complete. The fuel blend filling screen 700 can also include a digital stop button 718 to immediately halt the dispensing of further fluids into a fuel container 22 in the event of a malfunction or otherwise. The fuel blend filling screen 700 can also include links to other screens such as a database screen 722, a screen for showing the status of the fuel reservoirs 30, a settings screen 724 where the user can adjust and customize various settings, and a user screen 726 where a list of users may be displayed.

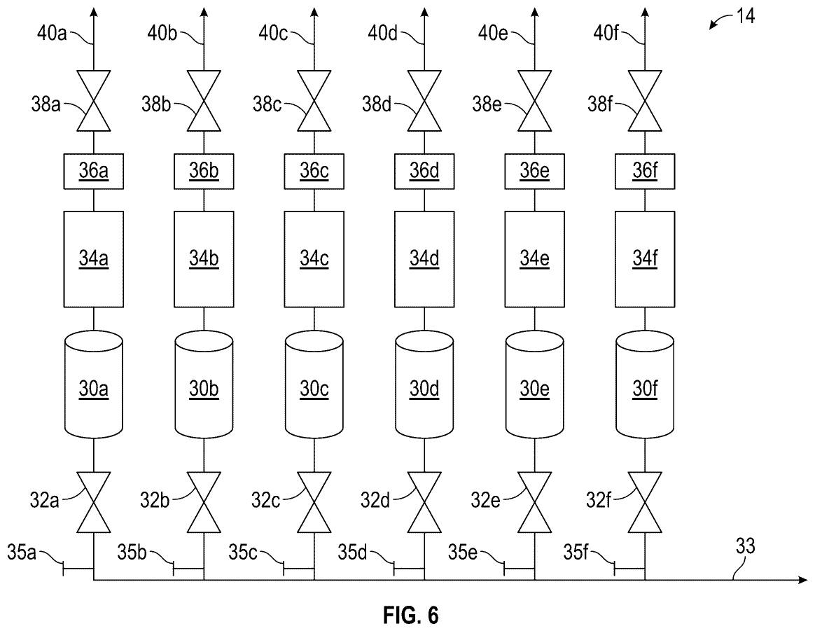

The user interface 102 may also include a diagram of the fluid storage portion 14 (similar to FIG. 6) that indicates the operating conditions of the components of the fluid storage portion 14 to a user (e.g., the open/close state of the fuel valve 38, the drain valves 32, the operating status of the fuel pumps 36, etc.). In some embodiments, the diagram 148 of the fluid storage portion 14 is interactive and has or includes icons or buttons that are pre-programmed to provide input signals to the controller 106 that correspond with predetermined output control signals. For example, each of the fuel valves 38 may be represented as an icon in the diagram and a user clicking on or touching (e.g., the display 104 may be a touchscreen) the icon for a particular one of the fuel valves 38 may transition that fuel valve 38 from the open position to the closed position, or vice versa. Similarly, each of the drain valves 32 may be represented by an icon in the diagram and a user clicking on or touching the icon for a particular one of the drain valves 32 may transition that valve from the open position to the closed position or vice versa. Alternatively or additionally, the diagram may include one or more buttons (e.g., digital buttons) that instruct the fuel valves 38 and/or the drain valves 32. For example, the diagram may include a fill reservoir button for at least a portion of the fuel reservoirs 30 (e.g., at least three of the fuel reservoirs 30), and a drain reservoir button for at least a portion of the fuel reservoirs 30 (e.g., at least three of the fuel reservoirs 30). In some embodiments, in response to a user clicking on or touching one of the fill reservoir buttons, the controller 106 is configured to instruct the respective fuel valve 38 to actuate, move, or otherwise transition to the closed position and instruct the drain valve to 32 actuate, move, or otherwise transition to the open position to facilitate filling the respective filling port 35 of the respective fuel reservoir 30. In some embodiments, in response to a user clicking on or touching one of the drain reservoir buttons, the controller 106 instructs the drain valve 32 that corresponds with the fuel reservoir 30 being drained to actuate or move from the closed position to an open position to allow the fuel from the respective fuel reservoir 30 and the respective fuel filter 34 to drain into the drain line 33. In some embodiments, the controller 106 may instruct the respective drain valve 32 to remain open for a predetermined amount of time after the drain button is activated and then automatically close the first drain valve 32 after the predetermined amount of time. In some embodiments, the controller 106 may instruct the respective drain valve 32 to remain open until the drain button is deactivated (e.g., clicked on or touched again).

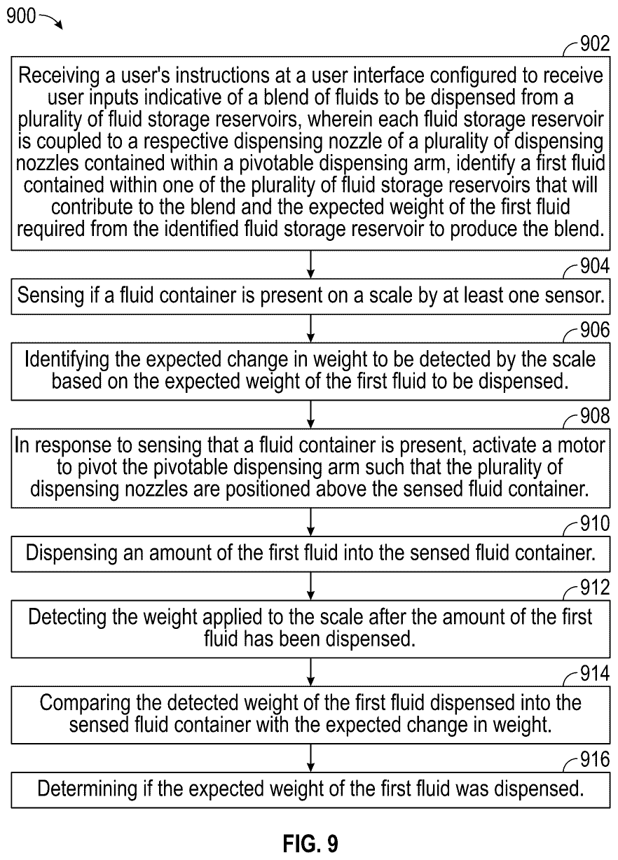

FIG. 9 illustrates an exemplary embodiment of a method, process, or procedure 900 for using a gravimetric blending system. In general, the display, calculation, and control provided by the HMI 16 significantly simplifies and improves the precision of producing fuel blends as compared to analog prior art systems. Accordingly, the method 900 may initiate, at step 902, by receiving a user's instructions at a user interface 102 configured to receive user inputs indicative of a blend of fluids to be dispensed from a plurality of fluid storage reservoirs 30, wherein each fluid storage reservoir 30 is coupled to a respective dispensing nozzle 28 of a plurality of dispensing nozzles 28 contained within a pivotable dispensing arm 18, identify a first fluid contained within one of the plurality of fluid storage reservoirs 30 that will contribute to the blend of fluids and the expected weight of the first fluid required from the identified fluid storage reservoir 30 to produce the blend of fluids. The method 900 further includes step 904, by sensing if a fluid or fuel container 22 is present on a scale 20 by at least one sensor 24. Specifically, the fuel container 22 is sensed by the object detection sensor 24 to verify that a fuel container 22 is present on the scale 20 and to ensure that fuel is not wasted by dispensing it directly onto the scale 20 without a fuel container 22 present. The method 900 further includes step 906, of identifying the expected change in weight to be detected by the scale 20 based on the expected weight of the first fluid to be dispensed. The method 900 further includes step 908, where in response to sensing that a fluid or fuel container 22 is present, activate a stepper motor 25 to pivot the pivotable dispensing arm 18 such that the plurality of dispensing nozzles 28 are positioned above the sensed fluid or fuel container 22. The method 900 further includes step 910, of dispensing an amount of the first fluid into the sensed fluid container. The method 900 further includes step 912, of detecting the weight applied to the scale after the amount of the first fluid has been dispensed. The method 900 further includes step 914, of comparing the detected weight of the first fluid dispensed into the sensed fluid container with the expected change in weight. The method 900 further includes step 916, of determining if the expected weight of the first fluid was dispensed. Steps 902-916 are then repeated for each fuel that is needed to be dispensed to create the desired blend of fuels in the fuel container 22.

The fuel blends generated by the gravimetric blending system 10 may be utilized by a test engine that is configured to test various parameters of the specific fuel blend. For many embodiments, the HMI 16 is communicatively coupled to the test engine such that the HMI 16 may receive fuel blend instructions from the test engine. In this manner, the gravimetric blending system 10 may be utilized as a fuel blend printer such that fuel blend information is provided from the test engine and the gravimetric blending system 10 ‘prints’ the blend that corresponds with the fuel blend information provided by the test engine. The test engine may also be configured to request or otherwise receive fuel blend information for a fuel blend that was generated by the gravimetric blending system 10.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

In this specification, the word “comprising” is to be understood in its “open” sense, that is, in the sense of “including,” and thus not limited to its “closed” sense, that is the sense of “consisting only of.” A corresponding meaning is to be attributed to the corresponding words “comprise,” “comprised” and “comprises” where they appear.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and “right,” “front” and “rear,” “above” and “below” and the like are used as words of convenience to provide reference points and are not to be construed as limiting terms.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

In addition, the foregoing describes some embodiments of the disclosure, and alterations, modifications, additions and/or changes can be made thereto without departing from the scope and spirit of the disclosed embodiments, the embodiments being illustrative and not restrictive.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Furthermore, the disclosure is not to be limited to the illustrated implementations, but to the contrary, is intended to cover various modifications and equivalent arrangements included within the spirit and scope of the disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A gravimetric blending system comprising:
a plurality of fluid storage reservoirs;
a pivotable dispensing arm having a plurality of dispensing nozzles, each dispensing nozzle coupled to one of the plurality of fluid storage reservoirs, wherein each dispensing nozzle is configured to dispense a predetermined amount of fluid from each fluid storage reservoir into one or more fluid containers;
each of the plurality of fluid storage reservoirs having a pump configured to pump a fluid from the respective fluid storage reservoir to a respective dispensing nozzle when activated and a solenoid valve having a flow path between the respective fluid storage reservoir and the respective dispensing nozzle and configured to transition between an open state where the fluid may flow through the flow path and a closed state where fluid may not flow through the flow path;
a scale configured to detect a weight applied to the scale;
a user interface configured to receive user inputs indicative of a blend of fluids to be mixed from the fluids contained within the plurality of fluid storage reservoirs; and
a controller configured to:
receive the user inputs;
identify a first fluid contained within one of the plurality of fluid storage reservoirs that will contribute to the blend of fluids and a weight of the first fluid required from the identified fluid storage reservoir to produce the blend of fluids;
identify an expected change in weight to be detected by the scale based on the identified weight of the first fluid to be dispensed;
cause the pump associated with the identified fluid storage reservoir to activate and the solenoid valve associated with the identified fluid storage reservoir to actuate to the open state to dispense the identified weight of the first fluid from the identified fluid storage reservoir;
detect the weight applied to the scale after the identified weight of the first fluid has been dispensed;
compare the detected weight to the expected change in weight; and
determine if the expected weight of the first fluid was dispensed.

2. The gravimetric blending system of claim 1, wherein if the expected weight of the first fluid was not dispensed, the controller is configured to cause the user interface to display an error message indicating a difference between the expected weight of the first fluid and the weight of the first fluid dispensed.

3. The gravimetric blending system of claim 1, further comprising a capacitive object detection sensor configured to sense a presence of the one or more fluid containers placed on the scale.

4. The gravimetric blending system of claim 1, wherein the pivotable dispensing arm is configured to pivot at most about 35 degrees.

5. The gravimetric blending system of claim 1, further comprising a housing having a fluid storage portion having the plurality of fluid storage reservoirs and a dispensing portion having the pivotable dispensing arm and the scale.

6. The gravimetric blending system of claim 5, further comprising an remote fluid reservoir positioned remotely from the housing and coupled with at least one of the plurality of fluid storage reservoirs, the remote fluid reservoir is configured to provide a fluid to the at least one fluid storage reservoir.

7. The gravimetric blending system of claim 1, further comprising a dispensing tip positioned within the pivotable dispensing arm, wherein the dispensing tip is disc shaped and the plurality of dispensing nozzles are positioned radially about the dispensing tip.

8. The gravimetric blending system of claim 5, wherein the dispensing portion further comprises a dispensing containment member positioned to cover the scale and the pivotable dispensing arm, the dispensing containment member having an access panel.

9. The gravimetric blending system of claim 1, wherein at least one of the plurality of fluid storage reservoirs contains toluene, ISO octane, 80 octane, or nHeptane.

10. A gravimetric blending system comprising one or more memory devices configured to store instructions thereon that, when executed by one or more processors, cause the one or more processors to:
in response to receiving a user's instructions at a user interface configured to receive user inputs indicative of a blend of fluids to be dispensed from a plurality of fluid storage reservoirs, wherein each fluid storage reservoir is coupled to a respective dispensing nozzle of a plurality of dispensing nozzles contained within a pivotable dispensing arm, identify a first fluid contained within one of the plurality of fluid storage reservoirs that will contribute to the blend of fluids and an expected weight of the first fluid required from the identified fluid storage reservoir to produce the blend of fluids;
sense if a fluid container is present on a scale by at least one sensor;
identify an expected change in weight to be detected by the scale based on the expected weight of the first fluid to be dispensed;
in response to sensing that a fluid container is present, activate a motor to pivot the pivotable dispensing arm such that the plurality of dispensing nozzles are positioned above the sensed fluid container;
dispense an amount of the first fluid into the sensed fluid container;
detect the weight applied to the scale after the amount of the first fluid has been dispensed;
compare the detected weight of the first fluid dispensed into the sensed fluid container with the expected change in weight; and
determine if the expected weight of the first fluid was dispensed.

11. The gravimetric blending system of claim 10, further comprising if the expected weight of the first fluid was not dispensed, cause the user interface to display a visual alert.

12. The gravimetric blending system of claim 10, further comprising if the expected weight of the first fluid was not dispensed, cause the user interface to generate an audible alert.

13. The gravimetric blending system of claim 10, wherein the at least one sensor is a capacitive object detection sensor configured to sense a presence or absence of the fluid containers on the scale.

14. The gravimetric blending system of claim 10, wherein the pivotable dispensing arm is configured to pivot at most about 35 degrees.

15. The gravimetric blending system of claim 10, wherein the scale includes a plurality of dispensing locations that are each configured to receive a fluid container.

16. The gravimetric blending system of claim 10, further comprising a dispensing tip positioned about an end of the pivotable dispensing arm, wherein the dispensing tip is disc shaped and the plurality of dispensing nozzles are positioned radially about the dispensing tip.

17. A method of using a gravimetric blending system, the method comprising:
receiving a user's instructions at a user interface configured to receive user inputs indicative of a blend of fluids to be dispensed from a plurality of fluid storage reservoirs, wherein each fluid storage reservoir is coupled to a respective dispensing nozzle of a plurality of dispensing nozzles contained within a pivotable dispensing arm, identify a first fluid contained within one of the plurality of fluid storage reservoirs that will contribute to the blend of fluids and an expected weight of the first fluid required from the identified fluid storage reservoir to produce the blend of fluids;
sensing if a fluid container is present on a scale by at least one sensor;
identifying an expected change in weight to be detected by the scale based on the expected weight of the first fluid to be dispensed;
in response to sensing that a fluid container is present, activate a motor to pivot the pivotable dispensing arm such that the plurality of dispensing nozzles are positioned above the sensed fluid container;
dispensing an amount of the first fluid into the sensed fluid container;
detecting the weight applied to the scale after the amount of the first fluid has been dispensed;
comparing the detected weight of the first fluid dispensed into the sensed fluid container with the expected change in weight; and
determining if the expected weight of the first fluid was dispensed.

18. The method of claim 17, further comprising if the expected weight of the first fluid was not dispensed, causing the user interface to display a visual alert.

19. The method of claim 17, further comprising if the expected weight of the first fluid was not dispensed, causing the user interface to generate an audible alert.

20. The method of claim 17, further comprising determining if the dispensing nozzles are positioned above the sensed fluid container and if not, activating a motor to pivot the pivotable dispensing arm to position the dispensing nozzles above the sensed fluid container.
